(19) United States
(12) Patent Application Publication
(10) Pub. No.: US 2026/0146186 A1
(43) Pub. Date: May 28, 2026

(54) ADHESIVES AND METHODS OF MAKING AND USING THE SAME

(71) Applicant: E Ink Corporation, Billerica, MA (US)

(72) Inventors: Ariel Siegel, Billerica, MA (US); Michael Lis, North Andover, MA (US)

(21) Appl. No.: 19/401,086

(22) Filed: Nov. 25, 2025

Related U.S. Application Data
(60) Provisional application No. 63/725,266, filed on Nov. 26, 2024.

(51) Int. Cl. C09J 9/02; C09J 4/00; C09J 5/00; G02F 1/00; G02F 1/167; G02F 1/1675; G02F 1/16757; G02F 1/1676

(52) U.S. Cl. CPC C09J 9/02; C09J 4/00; C09J 5/00; G02F 1/0018; G02F 1/167; G02F 1/16757; G02F 1/1676; C09J 2301/408; C09J 2301/416; C09J 2433/00; G02F 2001/1678

(57) ABSTRACT

This disclosure describes conductive adhesive compositions that can be used to fabricate electro-optic devices. The compositions include acrylic or methacrylic oligomers, acrylate monomers, glycol ether co-solvents, and photoinitiators for UV curing. These adhesives enable thinner adhesive layers while maintaining excellent electrical conductivity across a wide temperature range. Articles of manufacture and electrophoretic displays using these adhesive compositions are also described.

### CROSS REFERENCE TO RELATED APPLICATIONS

This application claims priority to U.S. Application No. 63/725,266, filed 26 Nov. 2024, which is hereby incorporated by reference in its entirety.

### BACKGROUND OF THE INVENTION

This invention relates to compositions of adhesives for use in the fabrication of electro-optic devices with improved mechanical and electro-optic properties.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

One type of electro-optic display is the particle-based electrophoretic display, such as microencapsulated electrophoretic displays. The reference display has a substantially two dimensional arrangement of microcapsules each having therein an electrophoretic composition of a dielectric fluid and a suspension of charged pigment particles.

The manufacture of an electro-optic display normally involves at least one lamination operation. The selection of a lamination adhesive for use in an electro-optic display presents certain problems. Because the lamination adhesive is normally located between the electrodes, which apply the electric field needed to change the electrical state of the electro-optic medium, the conductive properties of the adhesive can influence performance greatly. In addition to the electrical properties, the lamination adhesive must fulfill several mechanical and rheological criteria, including strength of adhesive, flexibility, ability to withstand and flow at lamination temperatures, etc. Commonly used commercially-available lamination adhesives include polyurethanes.

Various approaches have been explored to improve the performance of electro-optic displays by modifying the adhesives. One approach involves doping the adhesives with salts or other materials. However, adhesives (e.g., polyurethane compositions) containing dopants may lead to undesirable void formation and require thicker layers during construction. Another approach involves an “UV planarization” technology to reduce the overall thickness of the assembly. However, an additional outer layer of adhesive is needed on top of the UV planarized layer, which incurs extra costs and complexity. Thus, there remains a need for alternative adhesive compositions with improved properties such as conductivity, adhesion, and optical characteristics.

### BRIEF SUMMARY OF THE INVENTION

The present invention relates to conductive adhesive compositions that may be used in the fabrication of electro-optic devices, particularly electrophoretic displays, with enhanced electrical and mechanical properties. The technology provides several key advantages, including improved low-temperature performance at temperatures as low as −20° C., reduced adhesive layer thickness, and enhanced high-temperature resolution with respect to lateral pixel coupling and contrast. The compositions achieve these benefits while requiring little or no dopant content to provide adequate conductivity across a wide temperature range.

Traditional adhesive systems for electro-optic displays suffer from several limitations that compromise device performance. Conventional polyurethane-based adhesives typically require high dopant concentrations to achieve sufficient conductivity at low temperatures. This leads to undesirable void formation and necessitate thicker adhesive layers during construction. Thick adhesive layers limit device operating windows and high-temperature resolution performance. Additionally, dopant migration from the adhesive into the capsule layer may reduce high-temperature performance, while migration to other adhesive layers may cause resolution loss.

The present invention overcomes these prior art limitations by providing UV-curable adhesive compositions comprising acrylic or methacrylic oligomers, acrylate monomers, and glycol ether co-solvents that may be applied in thinner layers without void formation risks. The conductive adhesive composition comprises from about 25 wt. % to about 45 wt. % of one or more acrylic or methacrylic oligomers; from about 50 wt. % to about 75 wt. % of a monomer comprising acrylate; from 0 to about 15 wt. % of a co-solvent comprising a glycol ether; and an effective amount of a photoinitiator to initiate curing of the conductive adhesive composition, wherein all weight percentages are percent by weight of the total composition. The glycol ether may comprise dipropylene glycol dimethyl ether (DMM) or tripropylene glycol methyl ether (TPM), and the composition may comprise from about 5 wt. % to about 15 wt. % of the co-solvent.

The one or more acrylic or methacrylic oligomers may comprise aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate oligomer, tin-free difunctional aliphatic urethane acrylate, low viscosity aliphatic urethane acrylate, tackifying acrylate, or combinations thereof, with aliphatic urethane acrylate being particularly preferred. The monomer comprising acrylate may comprise ethoxylated acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoxylated phenol acrylates, benzyl (meth)acrylate, phenoxylethyl (meth)acrylate, phenol (EO)n acrylate, methoxy PEG methacrylate, nonyl phenol (EO)n acrylate, nonyl phenol (PO)2 acrylate, and cyclic trimethylolpropane formal acrylate (CTFA) or combinations thereof, wherein n is selected from 2, 4, 6, and 8. In particular embodiments, the monomer comprising acrylate may comprise ethoxylated acrylate, caprolactone acrylate, isobornyl acrylate, or combinations thereof, with the ethoxylated acrylate optionally comprising 2(2-ethoxyethoxy) ethyl acrylate.

The photoinitiator may comprise TPO-L and may be present in an amount from about 1 wt. % to about 10 wt. % of the composition. The composition may further comprise an adhesion promoter, which may comprise one or more acidic monomers or oligomers and/or one or more acid esters. The composition exhibits advantageous electrical properties, including a volume resistivity less than 10¹¹ Ohm·cm at −20° C., less than 10¹⁰ Ohm·cm at 0° C., less than 10⁹ Ohm·cm at 25° C., or any combination thereof. The composition may have a volume resistivity in the range of 10⁷ to 10¹² Ohm·cm between −20° C. to 60° C., or more specifically in the range of 10⁸ to 10¹¹ Ohm·cm between −20° C. to 40° C. Additionally, the composition may have a glass transition temperature (Tg) less than −20° C. and an activation energy less than 0.80 eV.

The invention also provides an article of manufacture comprising a layer of the conductive adhesive composition in contact with a layer of electrophoretic medium, wherein the layer of electrophoretic medium comprises microcapsules having a microcapsule wall and an internal phase comprising a dispersion solvent and charged pigment particles suspended in the internal phase and capable of moving through the dispersion solvent upon application of an electric field to the microcapsules. The layer of the conductive adhesive composition may comprise less than 20 gsm of the conductive adhesive composition in contact with the layer of electrophoretic medium, and the conductive adhesive composition may be cured, particularly by UV radiation. Furthermore, the invention encompasses an electrophoretic display comprising a light-transmissive top electrode, the article of manufacture, and a backplane electrode, wherein the conductive adhesive composition is positioned between the light-transmissive top electrode and the electrophoretic medium. The electrophoretic display may have a Push Pull Sweep full gamut value over 15,000 at −20° C. and may further comprise a second layer of adhesive material in contact with the layer of electrophoretic medium positioned between the backplane electrode and the layer of the electrophoretic medium. This second layer of adhesive material may comprise from 0 to about 15 wt. % of the co-solvent comprising a glycol ether, such as DMM or TPM, and may further comprise a crosslinker and a dopant. The electrophoretic display may achieve a Push Pull Sweep full gamut value over 40,000 at 65° C.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows a representative schematic cross-section of a four-particle electro-optic display wherein the electro-optic medium is encapsulated in microcapsules.

FIG. 2A illustrates a schematic cross-section of an exemplary 2-layer front plane laminate. The ASL may has a thickness of about 25 gsm.

FIG. 2B illustrates a schematic cross-section of an exemplary 3-layer front plane laminate. The ASL may has a thickness of about 15-25 gsm and the CSL may has a thickness of about 1.2-4.5 gsm.

FIG. 3A illustrates a schematic cross-section of an exemplary 2-layer front plane laminate comprising planarized capsule structures. The surface roughness of the coated capsules is reduced.

FIG. 3B illustrates a schematic cross-section of an exemplary 3-layer front plane laminate comprising planarized capsule structures. The surface roughness of the coated capsules is reduced.

FIG. 4 illustrates a schematic cross-section of an exemplary UV Overcoated 3-layer structure. The ASL may have a thickness of about 15 gsm and the CSL may have a thickness of about 1.2-4.5 gsm.

FIG. 5 shows a simple push pull waveforms that can be used to achieve a set of primary colors in an optimized system including one reflective (white) particle, and three subtractive (cyan, yellow, magenta) particles, wherein two particles are negatively charged, but have different magnitudes, and two particles are positively charged, but have different magnitudes.

FIG. 6 shows the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 7A illustrates an exemplary equivalent circuit of a single pixel of an electro-optic display that uses an active matrix backplane with a storage capacitor.

FIG. 7B illustrates an exemplary equivalent circuit of a simplified electro-optic display of the invention, allowing driving in a row-column format.

FIG. 8 illustrates an exemplary electro-optic display that includes a display module. The electro-optic display also includes a processor, memory, one or more power supplies, and a controller. The electro-optic display may also include sensors to allow the electro-optic display to adjust operational parameters based upon the ambient environment, e.g., temperature and illumination.

FIG. 9 shows the Dynamic Mechanical Analysis (DMA) of UV Adhesives 88A vs. 89C at 1 Hz Frequency. Bulk adhesive samples ranging from 1-2 mm thickness were used for the DMA testing.

FIG. 10 illustrates the resistivity vs. temperature graphs of Standard VRA vs. UV Adhesive. Samples containing adhesives alone (between PET-ITO sheets) ranging from 15-20 um were used. Resistivity values take into account the area and thickness of the samples (Ohm*Area/Thickness=Ohm*cm²/cm=Ohm*cm).

FIG. 11 illustrates the activation Energy of VRA vs. UV Adhesives. Samples containing adhesives alone (between PET-ITO sheets) ranging from 15-20 um were used.

FIG. 12 shows the UV overcoating process.

FIG. 13 compares device performance (Push-Pull Sweep (PPS) full gamut vs. temperature) of the 3-layer FPL containing UV adhesive vs. comparator adhesive. Measurements were taken at −20, −10, 25, and 65° C.

FIG. 14 shows the electrical resistivity of the adhesives alone vs. temperature. Samples containing adhesives alone (between PET-ITO sheets) ranging from 15-20 um were used. Resistivity values take into account the area and thickness of the samples (Ohm*Area/Thickness=Ohm*cm²/cm=Ohm*cm).

FIG. 15 shows the activation energy of adhesives: traditional 2000 ppm VRA vs. UV adhesives. Samples containing adhesives alone (between PET-ITO sheets) ranging from 15-20 um were used.

FIG. 16 shows the device performance (Push-Pull Sweep (PPS) gamut vs. temperature) when incorporating DMM in UV ASL and CSL at the same levels. Measurements were taken at −20, −10, 25, and 65° C.

FIG. 17 shows gamut volume vs. temperature performances of VRA ASL with DMM addition.

FIG. 18 shows the TFT 65° C. checkerboard resolution of the MCC 13.3″ Panels.

FIG. 19 shows the ASL voids in Vega (w/ DMM) and the 2000 ppm VRA control in unstressed condition and at 85° C. storage after 240 hrs. Condition 1: 2000 ppm VRA, unstressed. Condition 2: 2000 ppm VRA, 85° C. storage. Condition 3: Vega with 5% DMM and CSL with 5% DMM, unstressed. Condition 4: Vega with 5% DMM and CSL with 5% DMM, 85° C. storage. Condition 5: Vega with 10% DMM and CSL with 10% DMM, unstressed. Condition 6: Vega with 10% DMM and CSL with 10% DMM, 85° C. storage.

FIG. 20 shows the ASL voids in Vega (w/ 10% DMM) and the VRA control in unstressed condition and at 85° C. storage after 10 days.

### DETAILED DESCRIPTION OF THE INVENTION

The disclosure is directed to conductive adhesive compositions, which may be used within a variety of electro-optic media and electro-optic displays. The compositions described herein exhibit desirable electrical and mechanical properties. They also allow for thinner layers of electro-optic media between electrodes, e.g., between a front electrode and a backplane, or between two transparent electrodes. Furthermore, the adhesive compositions described herein improve the performance of electro-optic devices containing the same, including improved color gamut, resolution, and contrast ratio.

### Electro-Optic Display

An electro-optic display, e.g., an electrophoretic display, may comprise a layer of an electro-optic medium and at least two other layers disposed on opposed sides of the electro-optic medium, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous (light-transmissive) electrode and the other electrode layer is patterned into a matrix of pixel electrodes, each of which defines one pixel of the display.

The term “light transmissive” is used in this patent and herein to mean that the layer thus designated transmits sufficient light to enable an observer, looking through that layer, to observe the change in display states of the electro-optic medium, which will normally be viewed through the light transmissive electrode layer and adjacent substrate (if present); in cases where the electro-optic medium displays a change in reflectivity at non-visible wavelengths, the term “light-transmissive” should of course be interpreted to refer to transmission of the relevant non-visible wavelengths.

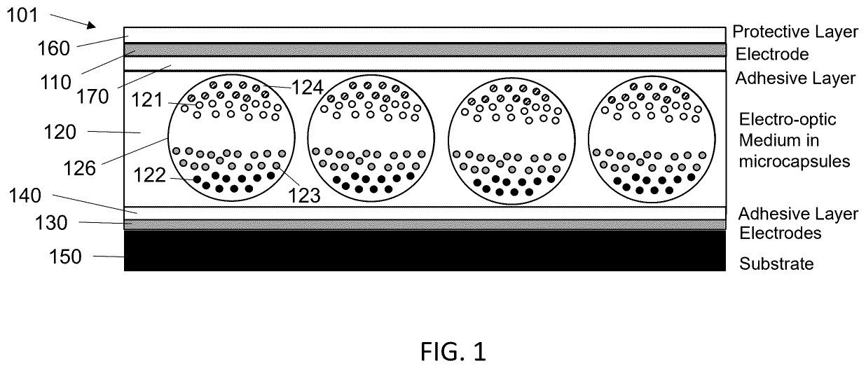

FIG. 1 illustrates an example of an electro-optic display comprising microcapsules. An electro-optic display (101) typically includes a top transparent electrode 110, an electro-optic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. The entire display stack may be disposed on a substrate 150, which may be rigid or flexible. The display may also include a protective layer 160, which may simply protect the top electrode 110 from damage, or it may envelop the entire display to prevent ingress of water, etc. While the electro-optic medium is depicted in FIG. 1 as being encapsulated in microcapsules, the electro-optic medium can also be encapsulated in microcells, e.g., embossed microcells that are filled with the electro-optic medium and then sealed with a sealing layer.

The manufacture of an electro-optic display normally involves at least one lamination operation. For example, manufacturing of an electrophoretic display may comprise coating an electrophoretic medium comprising capsules in a binder on to a flexible substrate comprising indium-tin-oxide (ITO) or a similar conductive coating (which acts as one electrode of the final display) on a plastic film, and drying the capsules/binder coating to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. In some embodiments, the backplane is flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

U.S. Pat. No. 6,982,178 describes a method of assembling a solid electro-optic display (including an encapsulated electrophoretic display) which is well adapted for mass production. This patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially. Such films are available in bulk from various producers, such as Saint Gobain.

As an alternative to the FPL as described above, U.S. Pat. No. 7,561,324 describes a so-called “double release sheet” which is a simplified version of the front plane laminate of U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate (FPL) already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

For example, U.S. Pat. No. 8,786,929 (incorporated by reference in its entirety) describes a self-supporting solid electro-optic medium, which can be prepared starting with a release sheet. A layer of the electro-optic medium is formed, by coating, printing or otherwise, on the release sheet, and thereafter an adhesive layer is formed over the electro-optic medium (i.e., on the opposed side of the electro-optic medium from the release sheet). The combined electro-optic medium and adhesive layer can then be used to apply the electro-optic medium to any desired substrate, which could be a three-dimensional object. If desired, a second layer of adhesive could be applied on the opposed side of the electro-optic medium from the layer first applied, thereby converting the electro-optic medium into a double-sided adhesive film which could be laminated, for example, to a backplane on one side and to a front substrate on the other. The use of a double release film allows the front substrate to be selected for properties such as color, water/oxygen barriers, ultra-violet filters, etc. The front substrate can be extremely thin. The final front substrate can alternatively be a stiff substrate, even glass or a glass color filter array.

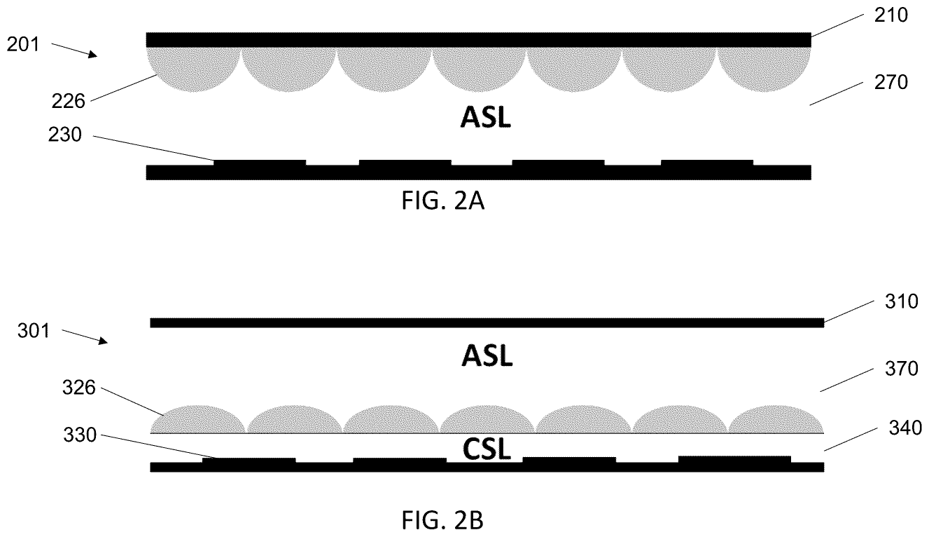

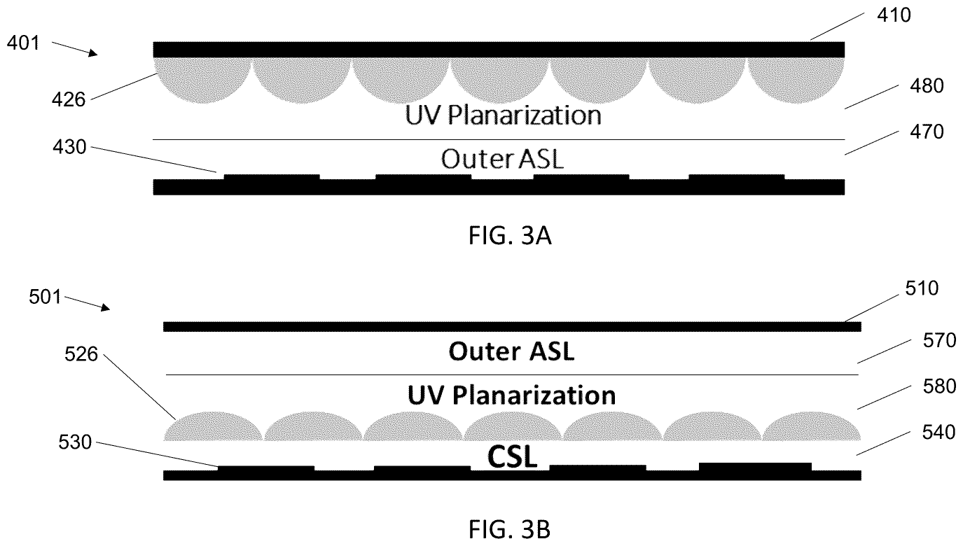

Two types of FPL structures, known as “2-layer” and “3-layer” structures have been commonly used. FIG. 2A illustrates a schematic cross-section of an exemplary 2-layer front plane laminate 201. The 2-layer structure is the simpler model, as the capsules 226 are directly coated onto atop plane 210 and the “air side” of the capsules are laminated onto the back plane 230 using an adhesive side layer (ASL) 270. The ASL adhesive layer is typically 25 gsm thick in order to allow full conformation of the adhesive on and planarization over the capsule layer. However, this thickness may present limitations on the device operating window and high temperature resolution. Because adhesives have temperature dependent resistivity, they need a large quantity of ions to provide sufficient conduction at low temperature (e.g., below 0° C.). If the adhesive is highly conductive at low temperatures, the FPL will exhibit undesirable fringe-effect blooming and lateral pixel coupling at high temperatures.

FIG. 2B illustrates a schematic cross-section of an exemplary 3-layer front plane laminate 301. It is a potential remedy to the obstacles mentioned above with balancing adhesive design and device operation. As shown in FIG. 2B, the “air side” is laminated to the top plane 310 on the rough side of capsules 326 using ASL 370 while the “capsule side” (release-facing) is laminated to the backplane 330 with an additional layer of capsule-side adhesive layer (CSL) 340. Because the capsule side is much flatter than the air side, this CSL adhesive 340 can be significantly thinner, down to 1.2 gsm. The thickness of the CSL can also limit the high temperature resolution potential, since the capsules are closer to the TFT. The ASL can thus be made more conductive without the same resolution penalty.

However, the standard 3-layer structure with the ASL design is not necessarily desirable. The ASL adhesive is still comparatively thick, usually requiring high salt (“dopant”) content (e.g., 2000 ppm or more) to be sufficiently conductive at low temperatures. Dopant migrating into the capsule layer will reduce high-temperature performance of the binder by draining current around the capsules. Dopant migration to the CSL causes resolution loss for reasons explained above. The 3-layer structure also has additional manufacturing costs associated with materials, substrates, and additional production processing.

Prior patents with alternate adhesive designs have attempted to reduce the overall thickness of the ASL layer, such as by using “UV Planarization” as described in U.S. Pat. No. 10,150,899. This FPL design uses an overcoated liquid resin on top of the capsule material which is cured by UV photopolymerization. That flatter surface is then be adhered to either the top or back plane by an outer ASL layer.

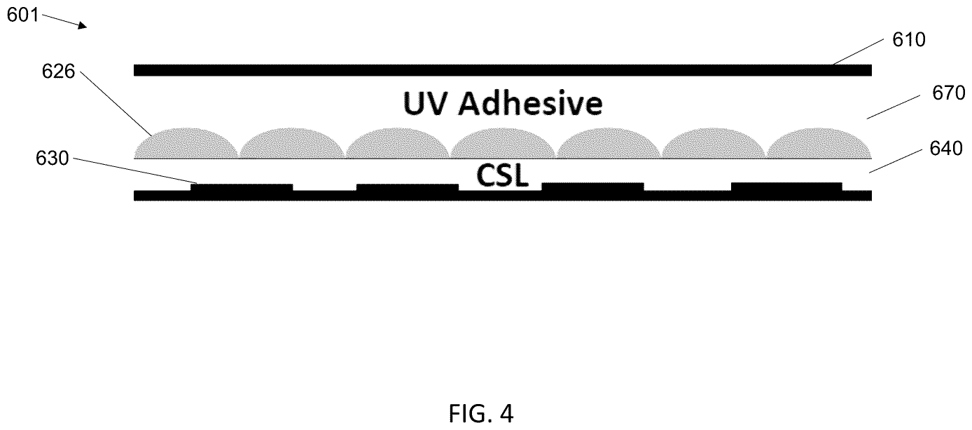

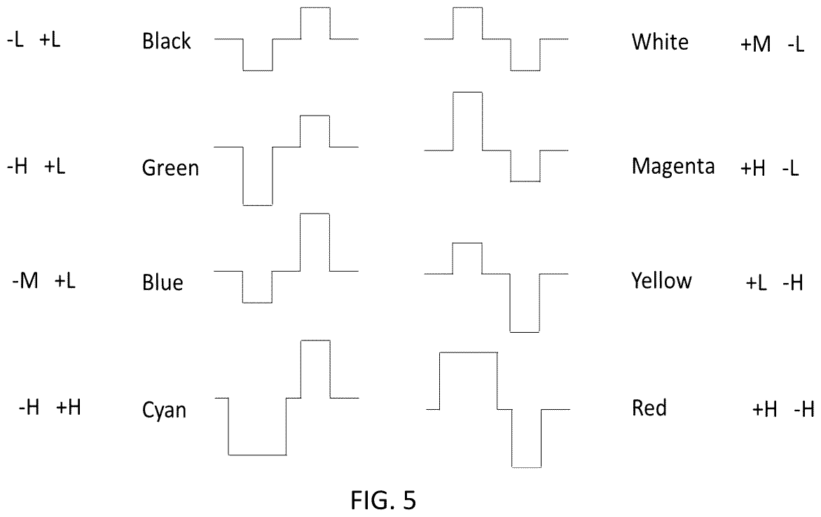

FIG. 3A shows a “direct” structure, which is a planarized 2-layer FPL 401. Capsules 426 are directly coated onto a top plane 410 and the capsule material is cured by a UV planarization layer 480. The “air side” of the capsules are laminated onto the back plane 430 using an adhesive side layer (ASL) 470.

FIG. 3B shows an “indirect” structure, which is a planarized 3-layer FPL 501. The “air side” is laminated to the top plane 510 on the rough side of capsules 526 in a UV planarize layer 580 using ASL 570 while the “capsule side” (release-facing) is laminated to the backplane 530 with an additional layer of capsule-side adhesive layer (CSL) 540. An additional layer of adhesive is needed, which results in additional costs, manufacture challenges, and complications to electric optical performances. Furthermore, the direct structure at its lowest achievable thickness was still too thick to provide adequate resolution performance at high temperatures.

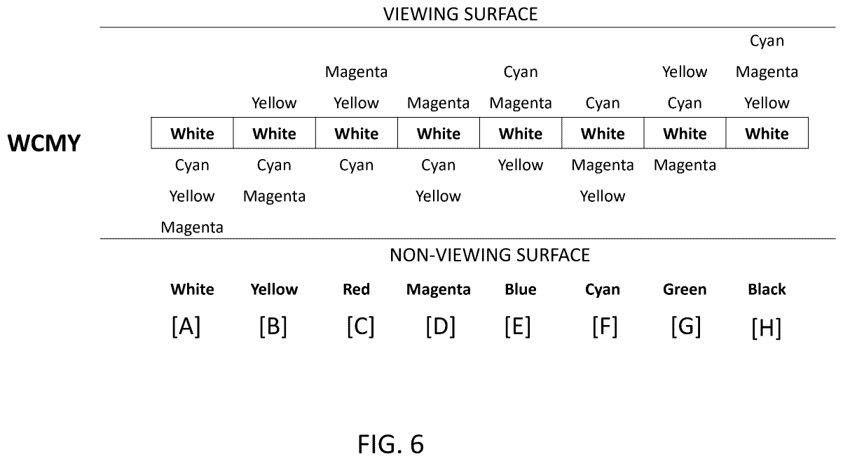

An alterative to the 2-layer and 3-layer FPLs described is overcoat UV adhesive comprising a thin ASL. The covercoat UV adhesive FPL 601 is illustrated in FIG. 4. The “air side” is laminated to the top plane 610 on the rough side of capsules 626 in an adhesive layer 570 while the “capsule side” (release-facing) is laminated to the backplane 630 with an additional layer of capsule-side adhesive layer (CSL) 640. The adhesive composition described herein facilitates the preparation of the FPL without the need for a UV planarization layer.

One aspect of the present invention provides an article of manufacture. The article of manufacture may comprise a layer of the conductive adhesive composition as described herein in contact with a layer of electrophoretic medium. The layer of electrophoretic medium comprises microcapsules having a microcapsule wall and an internal phase comprising a dispersion solvent and charged pigment particles suspended in the internal phase and capable of moving through the dispersion solvent upon application of an electric field to the microcapsules.

The layer of the conductive adhesive composition as described herein may comprise less than 25 gsm, less than 20 gsm, less than 15 gsm, or less than 10 gsm of the conductive adhesive composition in contact with the layer of electrophoretic medium. In some embodiments, the layer of the conductive adhesive composition as described herein comprises less than 20 gsm of the conductive adhesive composition in contact with the layer of electrophoretic medium.

In some embodiments, the conductive adhesive composition is cured. In some such embodiments, the conductive adhesive composition is cured by radiation, such as UV.

Another aspect of the present invention provides an electrophoretic display. The electrophoretic display comprises a light-transmissive top electrode, an article of manufacture as described herein, and a backplane electrode. The conductive adhesive composition is positioned between the light-transmissive top electrode and the electrophoretic medium.

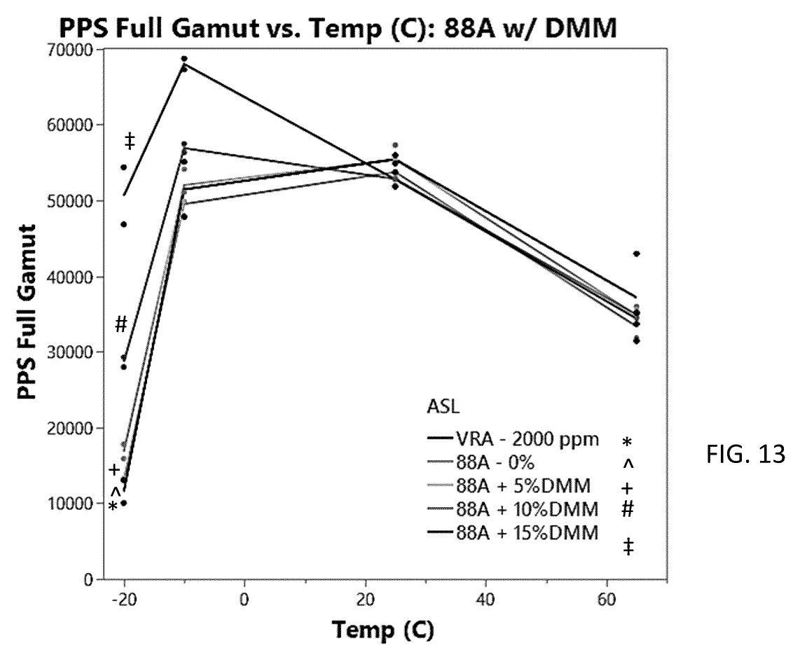

In some embodiments, the front plane laminate structure within the electrophoretic display may be assembled according to FIG. 12, following similar processes as those described in U.S. Pat. No. 10,150,899 (the content of which is incorporated here by reference in its entirety). For example, the adhesive composition described herein may be deposited on an electrophoretic medium (i.e., “ink”) atop a release, and a top film is then laminated atop the composition and electrophoretic medium by rolling the layers through lamination rollers. The top film may be a release or an electrode (e.g., PET/ITO electrode). When the top film is a release, a lamination step to adhere an electrode to the adhesive is performed. In some embodiments, the top film is a PET/ITO electrode. The adhesive may be cured with a UV or LED lamp before or during lamination. By changing pressure and coating speed settings, the thickness of the adhesive can be adjusted, for example, to between about 5-25 gsm, e.g., between 10-22 gsm, e.g., between 12-20 gsm, e.g., about 15 gsm.

Fabrication techniques that use UV curing, such as FIG. 12, allows for a wider range of temperature-sensitive materials to be incorporated into the devices. For example, polymer-based leads or wires, which may be susceptible to disruption by high temperatures, may be included in a layered assembly with UV curable adhesives. Additionally, performing the lamination at or near room temperature reduces outgassing that can lead to bubbles between the layers. In embodiments where the electro-optic medium is a liquid, e.g., water-based or water-permeated, UV curing will avoid swelling and/or dehydration of the medium. In such instances, UV curing will not only reduce the rate of defects in a layered assembly, but it will reduce the amount of post-process conditioning, e.g., rehydration, required in the process.

The release sheet used in the front plane laminate of the present invention can be of any known type, provided of course that it does not contain materials which might adversely affect the properties of the electro-optic medium, and numerous suitable types of release sheet will be known to those skilled in the art. Typical release sheets comprise a substrate such as paper or a plastic film coated with a low surface energy material, for example a silicone.

The performance of electro-optic displays, such as electrophoretic displays disclosed herein or prepared according to the methods disclosed herein, may be evaluated using a variety of parameters. In some embodiments, the performance of the display may be evaluated by the level of image sticking or “ghost images” observed from the display. In some embodiments, the performance of the display may be evaluated by the contrast ratio (CR) of the display. In some embodiments, the performance of the display may be evaluated by the color gamut of the display. In some embodiments, the performance of the displays may be evaluated by the level of fringe-effect blooming and lateral pixel coupling. In some embodiments, the performance of the displays may be evaluated by the white state (WS) of the display. In some embodiments, the performance of the displays may be evaluated by the dark state (DS) L* of the display. In some embodiments, the performance of the display may be evaluated by the resolution of the display. In some embodiments, the performance of the display may be evaluated by image stability of the display. In some embodiments, the performance of the display may be evaluated by the amount of cloudy spot mura and/or panther mura observed. In some embodiments, the performance of the display may be evaluated by the amount of time it takes for the display to produce one or more independent colors. In some instances, two or more of the foregoing parameters may be evaluated. (“Mura” is a generalized term for defects in the sealing layer that results in sub-optimal optical states when viewed through a microscope. Cloudy spot mura looks like evaporated water spots under the microscope while panther mura appears as streaks.)

For the electro-optic displays described herein, color contamination should be minimized to the point that the colors formed are commensurate with an industry standard for color rendition. One of the standards is SNAP (the standard for newspaper advertising production), which specifies L*, a* and b* values for each of the eight primary colors (red, green, blue, cyan magenta, yellow, black and white) by using The CIELAB color system. Alternatively, a color space may be described using the CIE L*C*h system.

In some embodiments, the gamut of the electrophoretic displays may be evaluated by driving the display using Push-Pull Sweep (PPS) waveforms at designated temperatures and measuring the L*a*b* values using a spectrophotometric electro-optic test bench under a calibrated light. However, the formulations described herein are widely applicable and can be used with both simpler (1 bit) or more complicated waveforms.

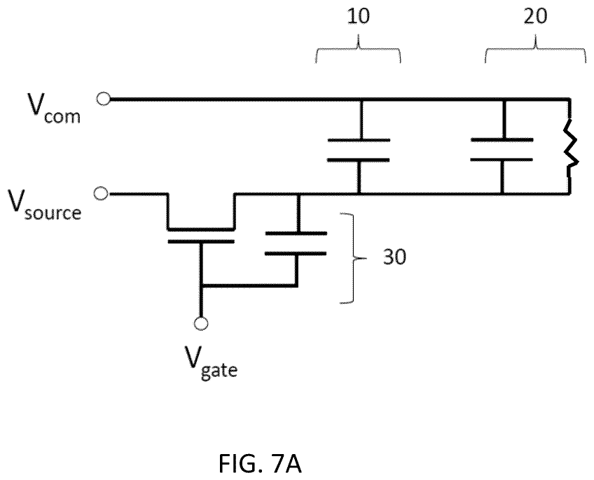

FIG. 5 shows exemplary waveforms (in simplified form) used to drive a four-particle color electro-optic display system. Such waveforms have a simple “push-pull” structure: i.e., they consist of a dipole comprising two pulses of opposite polarity. The magnitudes and lengths of these pulses determine the color obtained. At a minimum, there should be five such voltage levels. FIG. 3 shows high and low positive and negative voltages, as well as zero volts. Typically, “low” (L) refers to a range of about five-15V, while “high” (H) refers to a range of about 15-30V. In general, the higher the magnitude of the “high” voltages, the better the color gamut achieved by the display. The “medium” (M) level is typically around 15V; however, the value for M will depend somewhat on the composition of the particles, as well as the environment of the electro-optic medium. If only three voltages are available (i.e., +V_{high}, 0, and −V_{high}) it may be possible to achieve the same result as addressing at a lower voltage (say, V_{high}/n where n is a positive integer >1) by addressing with pulses of voltage V_{high} but with a duty cycle of 1/n. A particle set useful with the push-pull waveforms of FIG. 5 may include a negatively-charged white particle, a negatively-charged yellow particle, a positively-charged magenta particle and a positively-charged cyan particle.

While FIG. 5 shows an exemplary set of PPS waveforms, different (e.g., longer and more complex) waveforms may be adopted when measuring the color gamut of the display.

The electrophoretic displays described herein may have a Push Pull Sweep full gamut value over 10,000, over 15,000, over 20,000, over 25,000, over 30,000, over 35,000, over 40,000, over 45,000, over 50,000, over 55,000, or over 60,000 at −20° C. or at −10° C. In some embodiments, the electrophoretic display has a Push Pull Sweep full gamut value over 15,000 at −20° C.

In some embodiments, the electrophoretic display further comprises a second layer of adhesive material in contact with the layer of electrophoretic medium positioned between the backplane electrode and the layer of the electrophoretic medium.

In some embodiments, the second layer of adhesive material comprises from 0 to about 15 wt. % of the co-solvent comprising a glycol ether. For example, the second layer of adhesive material may comprise 5 wt. %, 10 wt. %, or 15 wt. % of the co-solvent based on the total weight of the second layer of adhesion. In some embodiments, the glycol ether may comprise dipropylene glycol dimethyl ether (DMM) or tripropylene glycol methyl ether (TPM).

In some embodiments, the second layer of adhesive material further comprises a crosslinker and a dopant. For example, the crosslinker may comprise diglycidyl aniline (DGA). The dopant may comprise tetrabutylammonium hexafluorophosphate (NPBF6).

The electrophoretic display comprising the second layer of adhesive material may have a Push Pull Sweep full gamut value over 10,000, over 15,000, over 20,000, over 25,000, over 30,000, over 35,000, over 40,000, over 45,000, over 50,000, over 55,000, or over 60,000 at −20° C. or at −10° C. In some embodiments, the electrophoretic display comprising the second layer of adhesive material may have a Push Pull Sweep full gamut value over 40,000 at 65° C.

### Adhesive Layer

Adhesive layers play an important role in controlling the overall voltage drop across the electro-optic medium. The voltage drop across the electro-optic medium is equal to the voltage drop across the electrodes, minus the voltage drop across the lamination adhesive. If the resistivity of the adhesive layer is too high, a substantial voltage drop will occur within the adhesive layer, requiring higher voltages between the electrodes to produce a working voltage drop at the electro-optic medium. This undeniably increases the voltage across the electrodes, however, because it increases power consumption, it may require the use of more complex and expensive control circuitry to produce and switch the increased voltages. On the other hand, if the resistivity of the adhesive layer is too low, there will be undesirable communication between adjacent electrodes (i.e., active matrix electrodes) or the device may short out. Also, because the volume resistivity of most materials decreases rapidly with increasing temperature, if the volume resistivity of the adhesive is too low, the performance of the display will vary greatly with temperatures substantially above room temperature. For example, increasing the conductivity of the lamination adhesive may increase pixel blooming (a phenomenon whereby the area of the electro-optic layer which changes optical state in response to change of voltage at a pixel electrode is larger than the pixel electrode itself), and this blooming tends to reduce the resolution of the display.

For these reasons, there is an optimum range of lamination adhesive resistivity values for use with most electro-optic media, this range varying with the resistivity of the electro-optic medium. The volume resistivities of encapsulated electrophoretic media are typically around 10¹⁰ Ohm cm, and the resistivities of other electro-optic media are usually of the same order of magnitude. Accordingly, the volume resistivity of the lamination adhesive should normally be around 10⁸ to 10¹¹ Ohm cm at the desired operating temperature, e.g., around 10⁹ to 10¹⁰ Ohm cm at the desired operating temperature. Although some displays are intended to operate around room temperature, typically around 20° C., in other instances the electro-optic displays are intended to perform at colder or warmer temperatures, including for outdoor use. Preferably, the lamination adhesive will also have a variation of volume resistivity with temperature that is similar to the electro-optic medium itself.

In addition to the electrical properties, the lamination adhesive must fulfill several mechanical and rheological criteria, including strength of adhesive, flexibility, ability to withstand and flow at lamination temperatures, etc. The number of commercially-available adhesives which can meet all the relevant electrical and mechanical criteria is small. In practice, commonly used adhesives include certain polyurethanes, such as those described in U.S. Pat. No. 7,342,068.

Dopants may be added into adhesive layers to enhance the low temperature performance. For example, to improve the performance of commercially available polyurethane adhesive compositions, the compositions can be doped with salts or other materials. Unfortunately, polyurethane compositions with salt and/or polymeric additives have been found to form voids when applied to electro-optic media having irregular surfaces. To counteract the voids, thicker layers of adhesive are applied during the construction of an electro-optic assembly, e.g., a front plane laminate or display. The thicker layers discourage void formation and improve planarity between the electro-optic media and the electrodes.

Another aspect of the present invention provides a conductive adhesive composition. The conductive adhesive composition comprises one or more acrylic or methacrylic oligomers, a monomer comprising acrylate, a co-solvent comprising a glycol ether, and an effective amount of a photoinitiator to initiate curing of the conductive adhesive composition.

As used herein the term “effective amount” refers to the amount of photoinitiator that provides the desired effect during the preparation or application of the composition. The desired effect includes the formation of reactive species by the photoinitiator when exposed to radiation, which initiates curing of the conductive adhesive composition.

The amount of one or more acrylic or methacrylic oligomers in the conductive adhesive composition may vary. In some embodiments, the one or more acrylic or methacrylic oligomers in the adhesive is at least 25 wt. %, at least 30 wt. %, at least 35 wt. %, at least 40 wt. %, or at least 45 wt. % of the total conductive adhesion composition. In some embodiments, the total amount of oligomers present in the conductive adhesive composition may range from about 20 wt. % to about 60 wt. %, about 25 wt. % to about 55 wt. %, about 25 wt. % to about 35 wt. %, about 30 wt. % to about 50 wt. %, from about 35 wt. % to about 45 wt. %, or from about 30% to about 40%. In some embodiments, the conductive adhesive composition comprises from about 25 wt. % to about 35 wt. % of one or more acrylic or methacrylic oligomers. In some embodiments, the conductive adhesive composition comprises from about 35 wt. % to about 45 wt. % of one or more acrylic or methacrylic oligomers. In some embodiments, the conductive adhesive composition comprises from about 25 wt. % to about 45 wt. % of one or more acrylic or methacrylic oligomers.

The one or more acrylic or methacrylic oligomers may comprise aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate oligomer, difunctional aliphatic urethane acrylate, low viscosity aliphatic urethane acrylate, tackifying acrylate oligomer, and combinations thereof. A commercially available example of aliphatic urethane acrylate include SARTOMER® CN9018. A commercially available example of difunctional aliphatic urethane acrylate oligomer diluted with ethoxylated trimethylolpropane triacrylate include SARTOMER® CN966H90. A commercially available example of aliphatic urethane acrylate blended with isobornyl acrylate include SARTOMER® CN966J75. A commercially available example of tin-free aliphatic urethane acrylate oligomer include SARTOMER® CN9071. A commercially available example of difunctional aliphatic urethane acrylate include SARTOMER® CN9073. A commercially available example of low viscosity aliphatic urethane acrylate include SARTOMER® CN9074. A commercially available example of tackifying acrylate oligomer include SARTOMER® CN3007 and SARTOMER® CN3008. In some embodiments, the one or more acrylic or methacrylic oligomers comprises aliphatic urethane acrylate, such as SARTOMER® CN9018.

The amount of monomer comprising acrylate in the conductive adhesive composition may vary. In some embodiments, the monomer comprising acrylate may comprise one or more different species of such monomers. In some embodiments, the amount of monomer comprising acrylate in the adhesive is at least at least 50 wt. %, at least 55 wt. %, at least 60 wt. %, at least 65 wt. %, at least 70 wt. %, or at least 75 wt. % of the total conductive adhesion composition. In some embodiments, the amount of each species of monomer within the monomer comprising acrylate is at least at least 20 wt. %, at least 25 wt. %, at least 30 wt. %, at least 35 wt. %, at least 40 wt. %, at least 45 wt. %, at least 50 wt. %, or at least 55 wt. % of the total conductive adhesion composition. In some embodiments, the total amount of monomer comprising acrylate in the adhesive composition may range from about 30 wt. % to about 95 wt. %, from about 35 wt. % to about 90 wt. %, from about 40 wt. % to about 80 wt. %, from about 50 wt. % to about 75 wt. %, from about 50 wt. % to about 70 wt. %, from about 50 wt. % to about 65 wt. %, or from about 50 wt. % to about 60 wt. %. In some embodiments, the amount of each type of monomer within the monomer comprising acrylate may be from about 50 wt. % to about 75 wt. %, from about 50 wt. % to about 70 wt. %, or from about 50 wt. % to about 65 wt. %. In some embodiments, the conductive adhesive composition comprises from about 50 wt. % to about 75 wt. % of a monomer comprising acrylate.

The monomer comprising acrylate may comprise ethoxylated acrylate (e.g., 2(2-ethoxyethoxy) ethyl acrylate), 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoxylated phenol acrylates, benzyl (meth)acrylate, phenoxylethyl (meth)acrylate, phenol (EO)ₙ acrylate, methoxy PEG methacrylate, nonyl phenol (EO)ₙ acrylate, nonyl phenol (PO)₂ acrylate, and cyclic trimethylolpropane formal acrylate (CTFA) and combinations thereof, wherein n is selected from 2, 4, 6, and 8. Commercially available examples of ethoxylated acrylate, such as 2(2-ethoxyethoxy) ethyl acrylate, include SARTOMER® SR256. Commercially available examples of caprolactone acrylate include SARTOMER® SR495B. Commercially available examples of isobornyl acrylate include SARTOMER® SR506A. In some embodiments, the monomer comprising acrylate comprises ethoxylated acrylate, caprolactone acrylate, isobornyl acrylate, or combinations thereof. In some embodiments, the monomer comprising acrylate comprises ethoxylated acrylate, wherein the ethoxylated acrylate comprises 2(2-ethoxyethoxy) ethyl acrylate, such as SARTOMER® SR256. In some embodiments, the monomer comprising acrylate comprises caprolactone acrylate, such as SARTOMER® SR495B. and isobornyl acrylate, such as SARTOMER® SR506A.

The amount of photoinitiator in the conductive adhesive composition may vary. In some embodiments, the amount of photo initiator in the conductive adhesive is at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, or at least 15 wt. % of the total conductive adhesion composition. In some embodiments, the total amount of photo initiator present in the conductive adhesive composition may range from about 1 wt. % to about 10 wt. %, about 2 wt. % to about 9 wt. %, about 4 wt. % to about 8 wt. %, or about 5 wt. % to about 7 wt. %. In some embodiments, the conductive adhesive composition comprises from about 1 wt. % to about 10 wt. % of the photoinitiator.

The photoinitiator may be selected from a wide range of Type I or Type II photoinitiators. In some embodiments, the photoinitiator may be selected from polyesteracrylates, epoxyacrylates, benzophenones, and phosphine oxides. Alternative photoinitiators may include Omnirad 369, Omnipol TP (oligomeric TPO), DETX, Keocoumarin, Photomer 4697, or Michler's Ketone. In some embodiments, the photoinitiator comprises TPO-L.

In some embodiments, the conductive adhesive composition may comprise a co-solvent. The amount of co-solvent in the conductive adhesive may vary. In some embodiments, the amount of co-solvent in the conductive adhesive is 0 wt. %, at least 1 wt. %, at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, or at least 15 wt. % of the total conductive adhesion composition. In some embodiments, the total amount of co-solvent present in the conductive adhesive may range from about 0 wt. % to about 25 wt. %, from about 0 wt. % to about 20 wt. %, from about 0 wt. % to about 15 wt. %, from about 0 wt. % to about 10 wt. %, from about 5 wt. % to about 15 wt. %, or from about 5 wt. % to about 10 wt. %.

The co-solvent may comprise a glycol ether, such as dipropylene glycol dimethyl ether (DMM) or tripropylene glycol methyl ether (TPM). Other glycol ethers, such as propylene glycol methyl ether, dipropylene glycol methyl ether, propylene glycol n-propyl ether, dipropylene glycol n-propyl ether, propylene glycol n-butyl ether, dipropylene glycol n-butyl ether, tripropylene glycol n-butyl ether, propylene glycol phenyl ether, as well as the corresponding methyl or dimethyl ether acetates, and propylene glycol diacetate, may also be used. In some embodiments, the conductive adhesive composition comprises from 0 to about 15 wt. % of the co-solvent comprising a glycol ether. In some embodiments, the conductive adhesive composition comprises from 5 wt. % to about 15 wt. % of the co-solvent comprising a glycol ether. In some embodiments, the co-solvent comprises DMM. In some embodiments, the co-solvent comprises TPM.

In some embodiments, the conductive adhesive composition may optionally further comprise an adhesion promoter. The amount of adhesion promoter present in the conductive adhesive composition may vary. In some embodiments, the amount of adhesion promoter present in the adhesive is 0 wt. %, at least 1 wt. %, at least 5 wt. %, at least 10 wt. %, at least 15 wt. %, or at least 20 wt. % of the total conductive adhesion composition. In some embodiments, the total amount of adhesion promoter present in the conductive adhesive composition may range from about 0 wt. % to about 25 wt. %, about 0 wt. % to about 20 wt. %, from about 0 wt. % to about 15 wt. %, or from about 0% to about 10%. In some embodiments, the conductive adhesive composition further comprises 0 to 10 wt. % of the adhesion promoter.

In some embodiments, the adhesion promoter comprises one or more acidic monomers or oligomers and/or one or more acid esters. In some embodiments, the adhesion promoter comprises one or more acidic monomers or oligomers selected from acidic acrylates, acrylic acid, 2-carboxyethyl acrylate, and combinations thereof. A commercially available example of acidic acrylates includes SARTOMER® CD9055. In some embodiments, the adhesion promoter comprises SARTOMER® CD9055.

In some embodiments, the adhesion promoter comprises one or more acidic monomers or oligomers selected from 2-hydroxyethyl methacrylate phosphate in 2-(2-ethoxyethoxy)ethyl acrylate, 2-hydroxyethyl methacrylate phosphate in ethoxylated trimethylolpropane triacrylate, high entropy alloy (HEA) phosphate in ethoxylated trimethylolpropane triacrylate, or an acid-based adhesion promoter or combinations thereof. A commercially available example of 2-hydroxyethyl methacrylate phosphate in 2-(2-ethoxyethoxy)ethyl acrylate includes SARTOMER® SR9050. A commercially available example of 2-hydroxyethyl methacrylate phosphate in ethoxylated trimethylolpropane triacrylate includes SARTOMER® SR9051. A commercially available examples of high entropy alloy (HEA) phosphate in ethoxylated trimethylolpropane triacrylate includes SARTOMER® SR9053. A commercially available example of an acid-based adhesion promoter includes SARTOMER® SR9054.

The conductive adhesive of the invention can be used to planarize (make smooth) surfaces with undesired surface morphology, while leaving the surface prepared for bonding or laminating with another structure. For example, the compositions can be spread over an irregular surface and cured to create an adhesive layer that is thin, smooth, and with substantially no voids left between the irregular surface and the composition. While any number of irregular surfaces can be smoothed with the described formulations, the formulations are well suited for the fabrication of microelectronics where there is a need for careful control of the thickness and resistivity of intervening adhesive layers. As described herein, the formulations can be distributed over a surface with spraying, spreading, laminating, pouring, or spin coating. Once applied, the composition can be cured, e.g., by applying heat or by activating with light, e.g., UV light.

The conductive adhesive can be used for a variety of applications, such as in the construction of an electro-optic display. The adhesive disclosed herein may also include metal oxide particles, e.g., metal oxide nanoparticles. The metal oxide nanoparticles can be selected to alter the index of refraction of the composition so that the overall index of refraction of a layered active material, e.g., a front plane laminate (FPL), matches the index of refraction of the substrate upon which the FPL is placed.

In some embodiments, the conductive adhesives disclosed herein are substantially free of dopants.

In some embodiments, the conductive adhesive composition has a volume resistivity less than 10¹¹ Ohm·cm at −20° C., less than 10¹⁰ Ohm·cm at 0° C., less than 10⁹ Ohm·cm at 25° C., or any combinations thereof. Resistivity values disclosed herein take into account both the area and the thickness (Ohm*Area/Thickness=Ohm*cm²/cm=Ohm*cm).

In some embodiments, the conductive adhesive composition has a volume resistivity in the range of 10⁷ to 10¹² Ohm·cm between −20° C. to 60° C. In some embodiments, the conductive adhesive composition has a volume resistivity in the range of 10⁸ to 10¹¹ Ohm·cm between −20° C. to 40° C.

The conductive adhesive composition described herein may have a glass transition temperature (Tg) less than −10° C., less than −15° C., less than −20° C., less than −25° C., less than −30° C., less than −35° C., less than −40° C., or less than −45° C. In some embodiments, the conductive adhesive composition has a glass transition temperature (Tg) less than −20° C.

The conductive adhesive composition described herein may have an activation energy less than 0.90 eV, less than 0.80 eV, less than 0.70 eV, less than 0.60 eV, or less than 0.50 eV. In some embodiments, the conductive adhesive composition has an activation energy less than 0.80 eV.

In some embodiments, the conductive adhesive disclosed herein has a total void count of less than 20,000, less than 18,000, less than 15,000, less than 12,000, less than 10,000, less than 9,000, or less than 8,000, per 100 cm² at 85° C. storage after 5 days, 6 days, 7 days, 8 days, 9 days, or 10 days.

In some embodiments, the conductive adhesive disclosed herein has a total void count of less than 20,000, less than 18,000, less than 15,000, less than 12,000, less than 10,000, less than 9,000, less than 8,000, less than 7,000, or less than 6,000, per 100 cm² in unstressed condition after 5 days, 6 days, 7 days, 8 days, 9 days, or 10 days.

The conductive adhesive compositions disclosed herein may be incorporated in the fabrication of the variety of articles of manufacture, electrophoretic media, and electrophoretic displays disclosed herein.

The formulations of the invention, e.g., the adhesive compositions as described herein, overcome the shortcomings of the prior arts by providing adhesives with desirable thickness, conductivity, adhesion, and optical characteristics. The formulations are well-suited for use with a variety of electro-optic media and electro-optic displays. In some embodiments, the electro-optic devices, such as electrophoretic displays comprising the adhesives described herein demonstrate improved electric optical performances at both high and low temperatures comparing to electrophoretic displays comprising adhesives of alternative formulations.

### Electro-Optic Medium

In some embodiments, the electro-optic medium comprises an electrophoretic medium. Electrophoretic medium disclosed herein may comprise microcapsules having a microcapsule wall and an internal phase comprising a dispersion solvent and charged pigment particles suspended in the internal phase and capable of moving through the dispersion solvent upon application of an electric field to the microcapsule.

The dispersion solvent within the capsules may be of low dielectric constant (e.g., less than 10 or less than 3). In some embodiments, the solvent includes aliphatic hydrocarbons such as heptane, octane, and petroleum distillates such as Isopar (Exxon Mobil) or Isane® (Total); terpenes such as limonene, e.g., 1-limonene; and/or aromatic hydrocarbons such as toluene. The index of refraction of the internal phase may be modified with the addition of index matching agents such as Cargille® index matching fluids available from Cargille-Sacher Laboratories Inc. (Cedar Grove, N.J.).

The charged particles may vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. The electrophoretic medium may comprise pigments having white, black, cyan, magenta, yellow, blue, green, red, and other colors.

The electrophoretic medium may contain two types of charged particles having different colors, a first type of charged particles having a first charge polarity, and a second type of charged particles that has a second charged polarity opposite to the first charged polarity. For example, the first type of charged particles may be black and the second type of charged particles may be white.

In some embodiments, each capsule within the electrophoretic medium comprises two different kinds of charged pigment particles dispersed in a hydrocarbon solvent. In some embodiments, the two kinds of pigment particles are black and white.

The electrophoretic medium may contain three types of charged particles all having different colors, a first type of charged particles having a first charge polarity, a second type of charged particles having a second charge polarity that is opposite to the first charge polarity, and a third type of charge particles having a third charge polarity that is the same as the first or the second charge polarity. For example, the first type of charged particles may be black, the second type of charged particles may be white, and the third type of charged particles may be selected from the group consisting of red, yellow, blue, cyan, magenta, green, and orange.

The electrophoretic medium may contain four types of charged particles all having different colors, a first type of charged particles having a first charge polarity, a second type of charged particles having the first charge polarity, a third type of charge particles having a second charge polarity opposite to the first charge polarity, and a fourth type of charged particles having the second charge polarity. The magnitude of the charge of the first type of particles may be higher than the magnitude of the charge of the second type of particles, and the magnitude of the charge of the third type of particles may be higher than the charge of the fourth type of particles. For example, the first type of charged particles may be cyan, the second type of charged particles may be magenta, the third type of particles may be yellow and the fourth type of charged particles may be white.

The electrophoretic medium may contain four types of charged particles all having different colors, a first type of charged particles having a first charge polarity, a second type of charged particles having the first charge polarity, a third type of charge particles having the first charge polarity, and a fourth type of charged particles having a second charge polarity that is opposite to the first charge polarity. The magnitude of the charges of the first, second, and third particles may be different from each other. The magnitude of the charge of the third type of particles may be higher than the magnitude of the charge of the first type of particles that may be higher than the magnitude of the charge of the second type of particles. For example, the first type of particles may be cyan, the second type of particles may be magenta, the third type of particles may be yellow, and the fourth type of particles may be white.

The electrophoretic medium may contain five types of charged particles all having different colors, a first type of charged particles having a first charge polarity, a second type of charged particles having the first charge polarity, a third type of particles having the first charge polarity, a fourth type of particles having a second charge polarity that is opposite to the first charge polarity, and a fifth type of particles having the second charge polarity. The magnitude of the first, second, and third charges may be different from each other. The magnitude of the charge of the third type of particles may be higher than the magnitude of the charge of the first type of particles that may be higher than the magnitude of the charge of the second type of particles. The charge of the fourth type of particles may have higher charge than the fifth type of charged particles. For one example, the first type of particles may be cyan, the second type of particles may be magenta, the third type of particles may be black, the fourth type of particles may be yellow, and the fifth type of particles may be white.

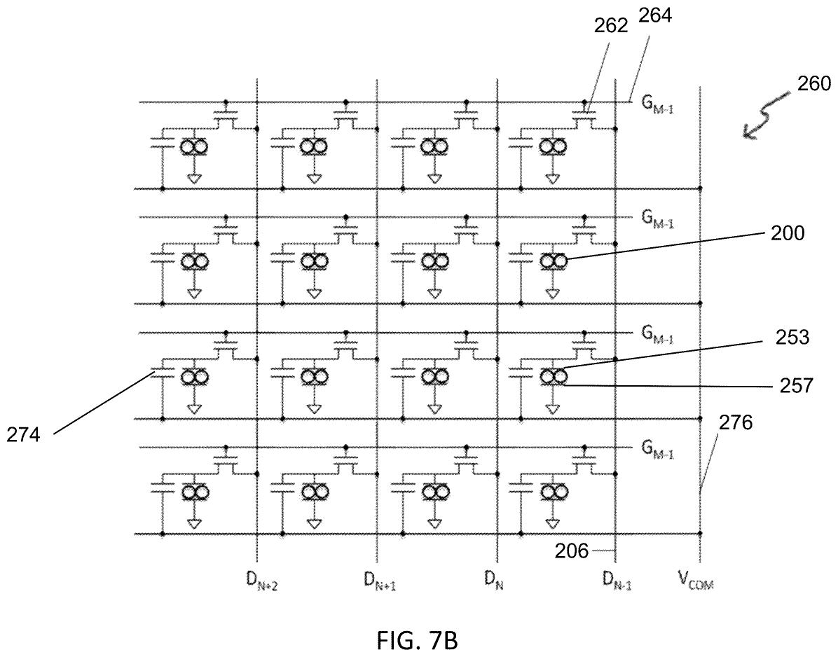

In some embodiments, the electro-optic displays disclosed herein includes an MCC (micro capsule color) platform that comprises colored particles. For example, as shown in FIG. 6, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of cross-talk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 6, in principle, works similar to printing on bright white paper in that the viewer only sees those colored pigments that are on the viewing side of the white pigment (i.e., the only pigment that scatters li8ht). In FIG. 6, it is assumed that the viewing surface of the display is at the top (as illustrated), i.e., a user views the display from this direction, and light is incident from this direction. As already noted, in preferred embodiments only one of the four particles used in the electro-optic medium of the present invention substantially scatters light, and in FIG. 6 this particle is assumed to be the white pigment. This light-scattering white particle forms a white reflector against which any particles above the white particles (as illustrated in FIG. 6) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 6), there are no particles above the white particles and the pixel simply displays a white color. When a single particle is above the white particles, the color of that single particle is displayed, yellow, magenta and cyan in Situations [B], [D] and [F] respectively in FIG. 6. When two particles lie above the white particles, the color displayed is a combination of those of these two particles; in FIG. 6, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 6), all the incoming light is absorbed by the three subtractive primary colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

As applied to the particle set illustrated in FIG. 6, producing eight independent primary colors refers to switching between white, yellow, red, magenta, blue, cyan, green, and black (Situations [A]-[H], respectively). The independent primary colors may be switched in any order. The time to produce all eight independent primary colors may be determined by detecting each of the eight independent primary colors or by detecting two (e.g., white and black) or more independent primary colors and approximating the time two switch between each of the eight independent primary colors.

In addition, the charged pigment particles may be functionalized with surface polymers to improve state stability. Such pigments are described in U.S. Patent Publication No. 2016/0085132, which is incorporated by reference in its entirety.

Encapsulation of the internal phase of the capsules may be accomplished in a number of different ways. Numerous suitable procedures for microencapsulation are detailed in both Microencapsulation, Processes and Applications, (I. E. Vandegaer, ed.), Plenum Press, New York, N.Y. (1974) and Gutcho, Microcapsules and Microencapsulation Techniques, Nuyes Data Corp., Park Ridge, N.J. (1976), both of which are hereby incorporated by reference herein. The processes fall into several general categories, all of which can be applied to the present invention: interfacial polymerization, in situ polymerization, physical processes, such as coextrusion and other phase separation processes, in-liquid curing, and simple/complex coacervation.

Numerous materials and processes may prove useful in formulating displays of the present invention. Useful materials for simple coacervation processes include, but are not limited to, gelatin, polyvinyl alcohol, polyvinyl acetate, and cellulosic derivatives, such as, for example, carboxymethylcellulose. Useful materials for complex coacervation processes include, but are not limited to, gelatin, acacia, carageenan, carboxymethylcellulose, hydrolized styrene anhydride copolymers, agar, alginate, casein, albumin, methyl vinyl ether co-maleic anhydride, and cellulose phthalate. Useful materials for phase separation processes include, but are not limited to, polystyrene, PMMA, polyethyl methacrylate, polybutyl methacrylate, ethyl cellulose, polyvinyl pyridine, and poly acrylonitrile. Useful materials for in situ polymerization processes include, but are not limited to, polyhydroxyamides, with aldehydes, melamine, or urea and formaldehyde; water-soluble oligomers of the condensate of melamine, or urea and formaldehyde; and vinyl monomers, such as, for example, styrene, MMA and acrylonitrile. Finally, useful materials for interfacial polymerization processes include, but are not limited to, diacyl chlorides, such as, for example, sebacoyl, adipoyl, and di- or poly-amines or alcohols, and isocyanates. Useful emulsion polymerization materials may include, but are not limited to, styrene, vinyl acetate, acrylic acid, butyl acrylate, t-butyl acrylate, methyl methacrylate, and butyl methacrylate.

### Driving the Device

For the most part, electrophoretic media, such as described above, are designed to be driven with low voltage square waves, such as produced by a driver circuit using a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extends over a large number of pixels, and normally the whole display is provided on the opposed side of the electro-optic medium. The single common electrode is coupled to the backplane via an isolated electrical connection, a.k.a., a “top plane connection.” The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, e.g., “ghosts” or “image sticking”.

The term impulse, when used to refer to driving an electrophoretic display, is used herein to refer to the integral of the applied voltage with respect to time during the period in which the display is driven. The term waveform, when used to refer to driving an electrophoretic display is used to describe a series or pattern of voltages provided to an electrophoretic medium over a given time period (seconds, frames, etc.) to produce a desired optical effect in the electrophoretic medium.

Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active matrix backplanes (260) because of the wider availability of fabrication facilities and the costs of the various starting materials. Amorphous silicon thin-film transistors may become unstable when supplied gate voltages that would allow switching of voltages higher than about +/−15V, e.g., +/−24V or +/−30V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active matrix backplanes (260), including IGZO, i.e., as described in U.S. Pat. No. 11,776,496, which is incorporated by reference in its entirety.

In some embodiments, the electrophoretic display may include only a first light-transmissive electrode, an electrophoretic medium, and a second (rear) electrode, which may also be light-transmissive. However, to produce a high-resolution display, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer framewidths are possible.

In a conventional electrophoretic display using an active matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to from the transistors and the “select” and “non-select” voltages applied to the gate electrodes can be positive and negative, respectively.

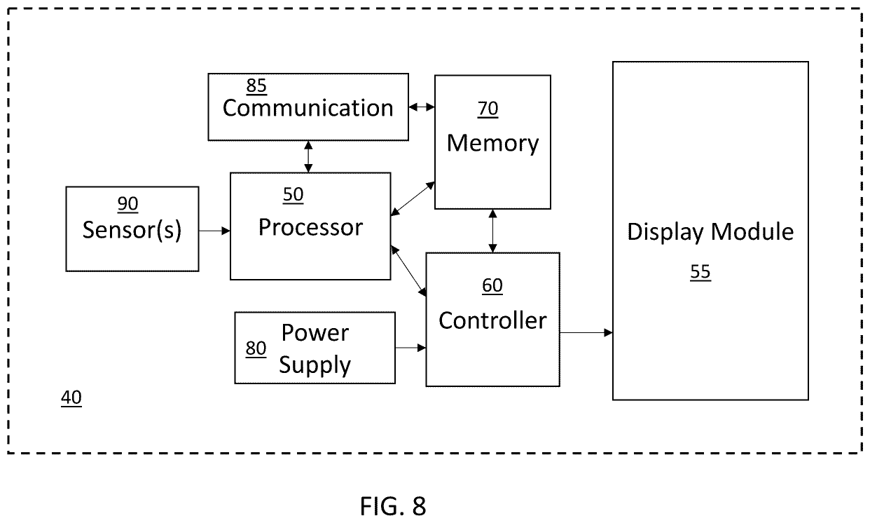

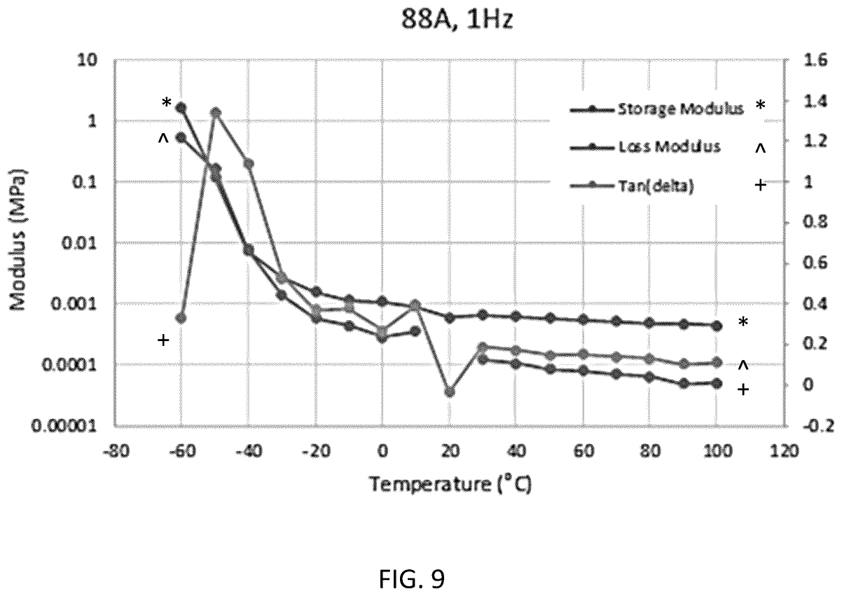

FIG. 7A depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts.

In some embodiments, the TFT array forms an active matrix 260 for image driving, as shown in FIG. 7B. For example, each pixel electrode 253 (corresponding to 130 in FIG. 1) is coupled to a thin-film transistor 262 patterned into an array, and connected to gate (row) driver lines 264 and source (column) driver lines 206, running at right angles to the gate drive lines 264. Also, typically, the common (top) light-transparent electrode 257 (corresponding to 110 in FIG. 1) has the form of a single continuous electrode while the other electrode or electrode layer is patterned into a matrix of pixel electrodes 253, each of which defines one pixel of the display. Between the pixel electrode 253 and the common electrode 257, an electrophoretic medium 200 can be disposed. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. Each pixel of the active matrix 260 also includes a storage capacitor 274 as discussed above with respect to FIG. 7A. The storage capacitors 274 may be coupled to a common potential (V_{com}) line 276.

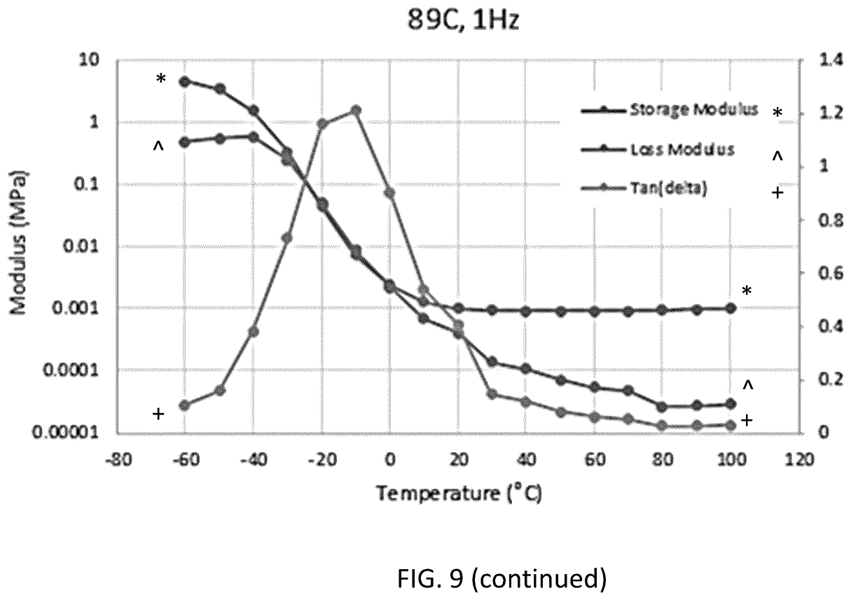

The active matrix 260 described with respect to FIG. 7B (i.e., including the electrophoretic medium 200 and the common light-transparent electrode 257) is typically covered by a protective sheet (e.g., integrated barrier) and sealed to create a display module 55, as shown in FIG. 8. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electro-optic displays are available from ULTRACHIP and NEXTRONIX.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

The term “weight percent”, “wt. %”, “wt. %,” “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

The phrase “such as” should be interpreted as “for example, including.” Moreover the use of any and all exemplary language, including but not limited to “such as”, is intended merely to better illuminate the invention and does not pose a limitation on the scope of the invention unless otherwise claimed.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or ‘B or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described embodiments or features contained within the same. Where no options or choices are disclosed regarding a particular embodiment or feature contained in the same, the modal verb “may” refers to an affirmative act regarding how to make or use and aspect of a described embodiment or feature contained in the same, or a definitive decision to use a specific skill regarding a described embodiment or feature contained in the same. In this latter context, the modal verb “may” has the same meaning and connotation as the auxiliary verb “can.”

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Formulation

Disclosed herein is an “Overcoat UV Adhesive”, which can achieve the FPL design comprising a thin ASL. See FIG. 4 for an exemplary lay-out of such FPL. Ideal low temperature performance without high temperature resolution loss can be achieved without the addition of a dopant. Specifically, this adhesive platform has shown low temperature performance at −20° C. that was otherwise not observed with traditional 3-layer structures.

The UV adhesive or resin disclosed herein comprises oligomer for structure and adhesive properties, monomer to influence viscosity and conductivity, initiator for photopolymerization, and co-solvent. For example, see formulation 88A in Table 1.

TABLE 1
UV Pressure Sensitive Adhesive (PSA) - 88A

| Material | Description | Wt % |
|---|---|---|
| CN9018 (Oligomer) | Difunctional Urethane Acrylate | 35-45 |
| SR256 (Monomer) | Monofunctional Ethoxylated Acrylate | 50-65 |
| TPO-L (Initiator) | Liquid Photoinitiator | 4-8 |
| DMM (co-solvent) | Dipropylene Glycol Dimethyl Ether | 0-15 |

The formulation of 88A may further comprise an adhesion promoter. Tripropylene glycol methyl ether (TPM) may also be used as a co-solvent instead of DMM. For example, see formulation 88A-2 in Table 2.

TABLE 2
UV Pressure Sensitive Adhesive (PSA) - 88A-2

| Material | Description | Wt % |
|---|---|---|
| CN9018 (Oligomer) | Difunctional Urethane Acrylate | 30-40 |
| SR256 (Monomer) | Monofunctional Ethoxylated Acrylate | 50-65 |
| TPO-L (Initiator) | Liquid Photoinitiator | 4-8 |
| DMM or TPM (co- | Dipropylene Glycol Dimethyl Ether or | 0-15 |
| solvent) | Tripropylene Glycol Methyl Ether | |
| CD9055 (Adhesion | Acidic acrylate adhesion promotor | 0-10 |
| Promotor) | | |

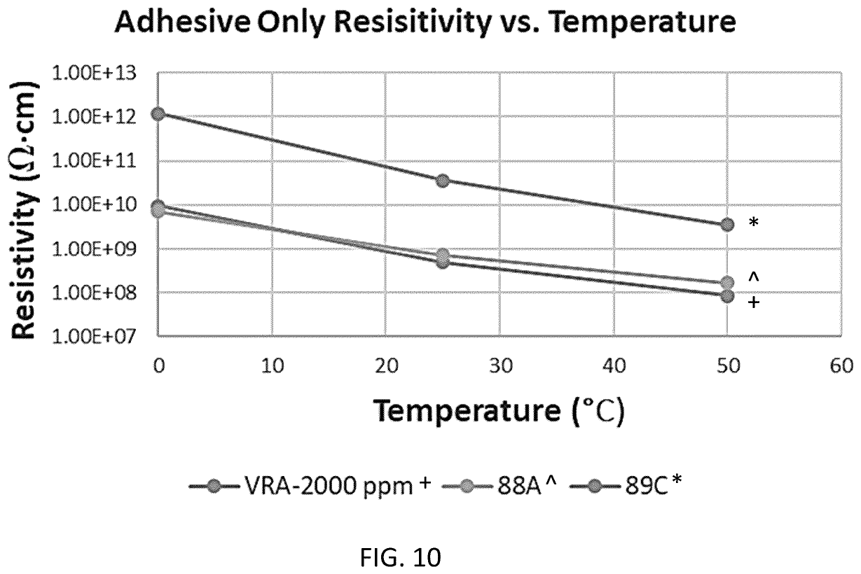

UV adhesive formulations with alternate monomer combinations can impact the glass transition temperature (Tg) and resistance of the adhesive, which impact the electro-optic performances specifically at low temperatures. An alternative adhesive formulation (89C) is shown in Table 3. The Dynamic Mechanical Analysis (DMA) Tg is significantly different between 88A and 89C, as seen in FIG. 9. The Tg of 88A is −50° C. whereas −15° C. for 89C by changing the monomer in the UV PSA formulation.

TABLE 3
UV Pressure Sensitive Adhesive (PSA) - 89C

| Material | Description | Wt % |
|---|---|---|
| CN9018 (Oligomer) | Difunctional Urethane Acrylate | 25-35 |
| SR495B (Monomer) | Caprolactone Acrylate | 25-45 |
| SR506A (Monomer) | Isobornyl Acrylate | 25-45 |
| TPO-L (Initiator) | Liquid Photoinitiator | 4-8 |

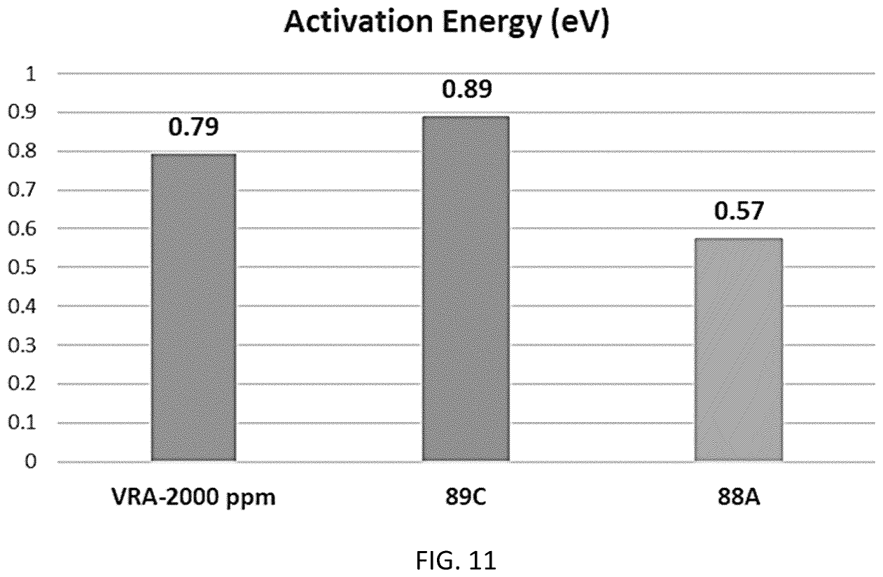

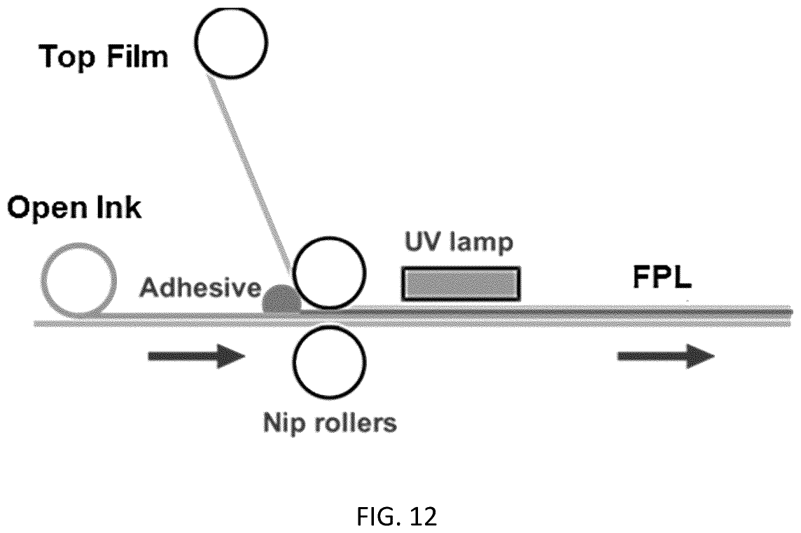

The variations in monomer selection for a UV pressure sensitive adhesive, not only impact the mechanical Tg, but also the resistivity and temperature response as seen in FIG. 10 and FIG. 11.

### Preparation

To construct the UV overcoated 3-layer structure, the following steps were followed (FIG. 12). An “open ink” process was utilized to prepare capsules on release film. The process and formulation are described U.S. Pat. No. 10,150,899, the contents of which are incorporated by reference in its entirety. UV adhesive (with DMM solvent) was applied in a wet nip process as depicted in FIG. 12. In this process, a liquid UV adhesive was applied to the “open ink” with an additional substrate (e.g., release film or ITO-PET) to ensure no material was transferred to the laminator rollers. By changing pressure and coating speed settings, the total adhesive thickness can be adjusted to target 15 gsm. The wet film was then cured with a UV or LED lamp. If the top film was release, PET/ITO was then laminated after this step. A CSL adhesive was coated on release at 1.2-4.5 gsm. This was laminated after removal of the ink-release film.

### Performance

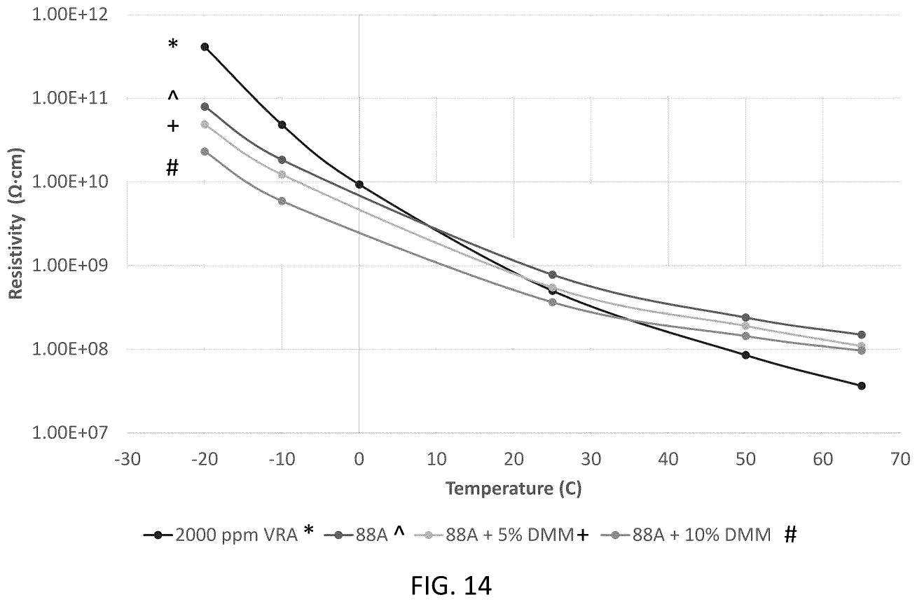

The performance of the FPL and adhesive design is shown in FIG. 13. The UV ASL 88A loaded with increasing levels of DMM from 0-15 wt. % was compared to a traditional 3-layer MCC with 2000 ppm ASL (control). At high temperatures, the performance of UV adhesive with any level of DMM was comparable to the control. However, at −10° C. and −20° C., the UV adhesive showed substantial improvements in device operation.

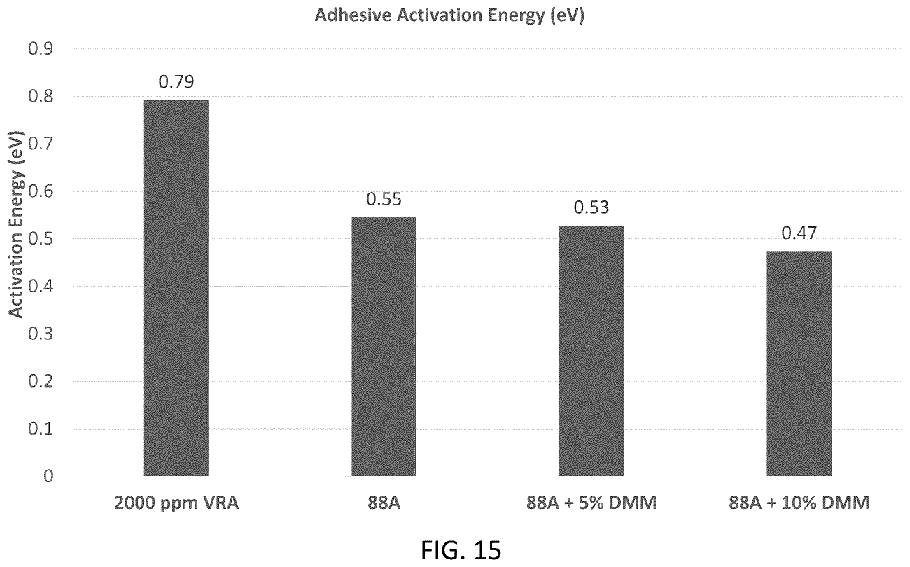

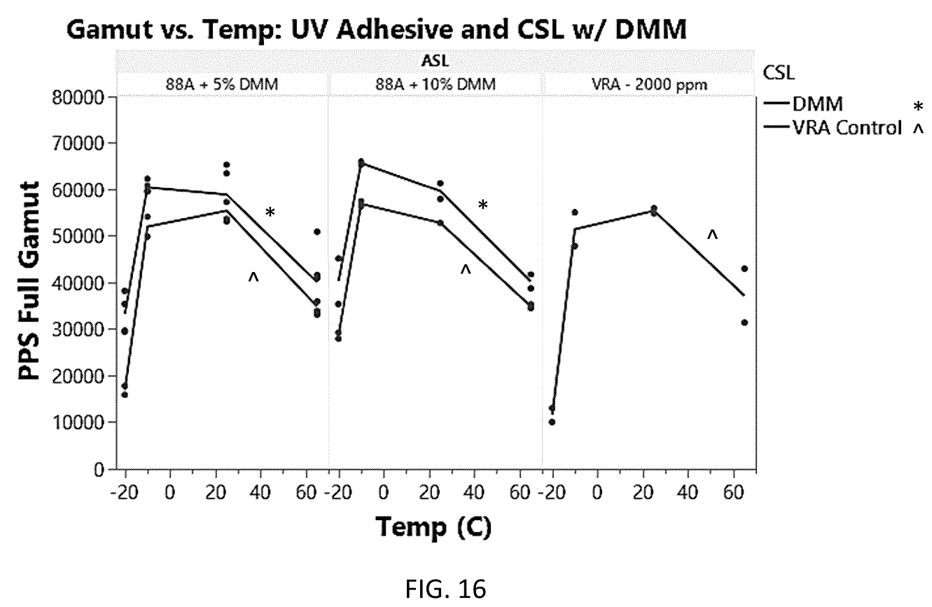

Fundamental investigations showed the electrical resistivity of the adhesive alone (FIG. 14) is not as sensitive as a standard adhesive (2000 ppm VRA) or as the UV adhesive with no solvent (i.e., DMM). Further analysis showed less electrical temperature sensitivity with activation energy. Increasing DMM loading reduces resistivity at low temperature without significant changes in high temperature (FIG. 15). This is one of the mechanistic explanations for the improved −20° C. performance.

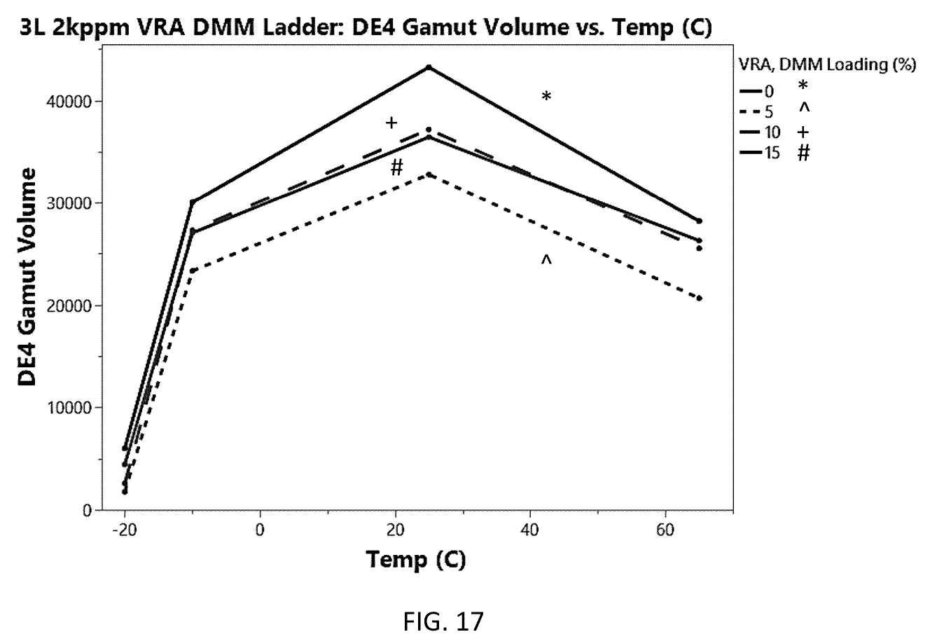

Additional low temperature operation improvement was observed when incorporating DMM to the CSL (FIG. 16). In this experiment, DMM was added at the same levels as those added to the ASL. For example, if UV ASL has 10 wt. % DMM, CSL has 10 wt. % as well. The CSL samples further comprise 2.4 wt. % of diglycidyl aniline (DGA) as crosslinker, and 180 ppm of tetrabutylammonium hexafluorophosphate (NPBF6) as dopant. As evidenced by FIG. 16, adding DMM to the CSL may be an option to achieve higher −20° C. gamut without massive implications or changes to the mechanical stability of the ASL. DMM levels in both ASL and CSL may be further optimized with respect to electro-optic operation performance while maintaining reliability requirements.

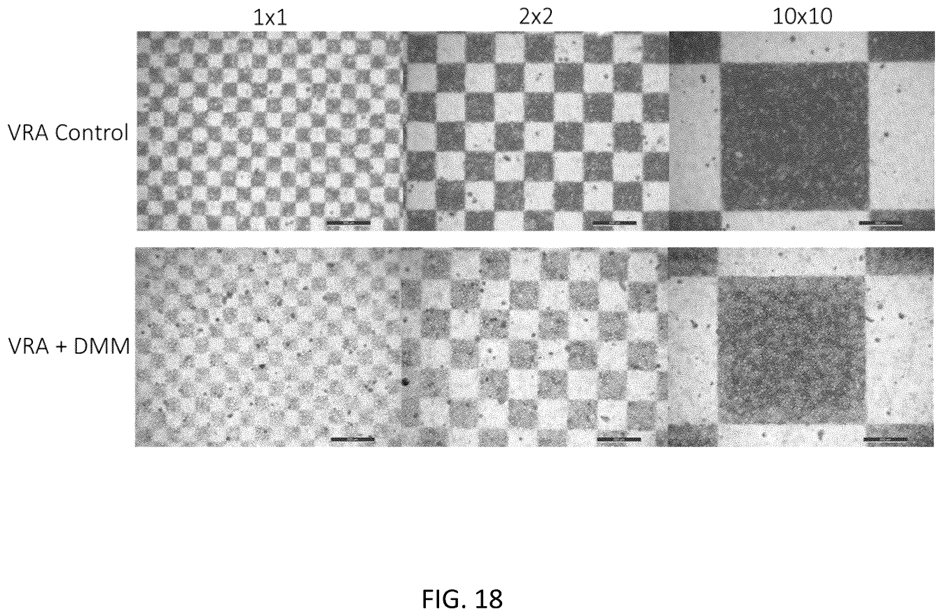

The addition of DMM co-solvent to a standard VRA ASL adhesive did not show the same low temperature performance benefits as observed by the UV adhesive. FIG. 17 indicates similar total weight % of DMM in VRA adhesive did not show a benefit at low temperatures. These results also indicate that overall color performance is significantly worse. DMM addition to capsule-based adhesives varies depending on the base chemistry that is used (i.e., waterborne PUD/VRA vs. UV Adhesive).

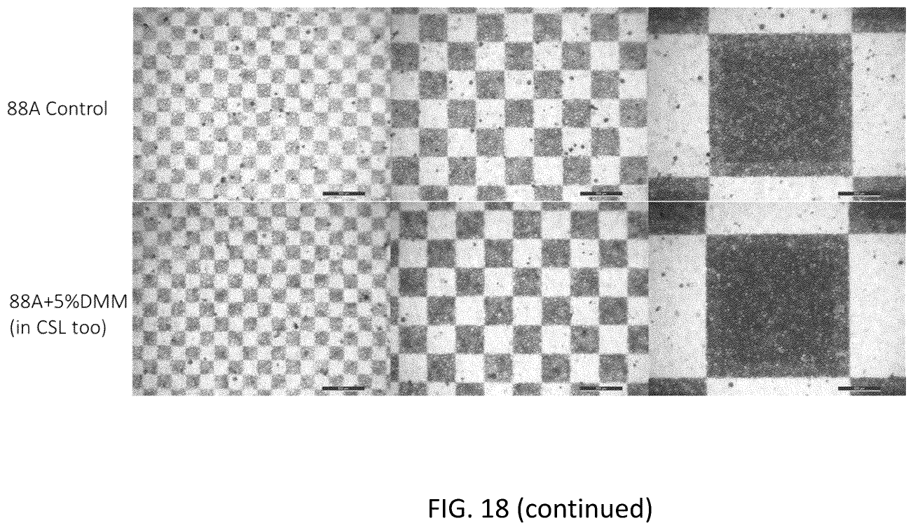

High-temperature resolution was also examined. High temperature thin film transistor (TFT) resolution testing used W&K waveform structures and test sequences in order to demonstrate resolution without extensive waveform tuning. FIG. 18 indicates that the addition of DMM to UV Adhesive improves lateral pixel coupling (LPC) observed to UV Adhesive control while also increasing contrast. Note: these microscopy images have a different white balance. Further adhesive optimization can improve the performance of the UV adhesive compared to the VRA—2000 ppm control.

Table 4 compares the performance between UV adhesive Vega (i.e., formulation 88A-2) and the 2000 ppm VRA control. 88A-2 demonstrated improved activation energy, approaching the theoretical limit of 0.4 eV. 88A-2 demonstrated improved thickness. 88A-2 demonstrated improved color performance at −20° C. 88A-2 also demonstrated complete curing after UV exposure. Additionally, 88A-2 demonstrated no void growth over 10 days at 85° C. 88A-2 also showed that there was no sacrifice at 65° C. or visible difference in the grain (data not shown).

TABLE 4
UV adhesive performance vs 2000 ppm VRA Control performance

| Metric | Control | Vega |
|---|---|---|
| Activation Energy | 0.79 | 0.47 |
| Thickness | 25gsm | 15gsm |
| −20° C. PPS Gamut | 5k | 45k |
| 25° C. PPS Gamut | 75k | 67k |
| 65° C. PPS Gamut | 50k | 45k |
| ASL Peel Strength | 30N | 10N |
| Total voids at | ~33000 | ~8500 |
| 85° C. (240 hrs) | | |
| RT conditioning time | 10 days | 0 days |

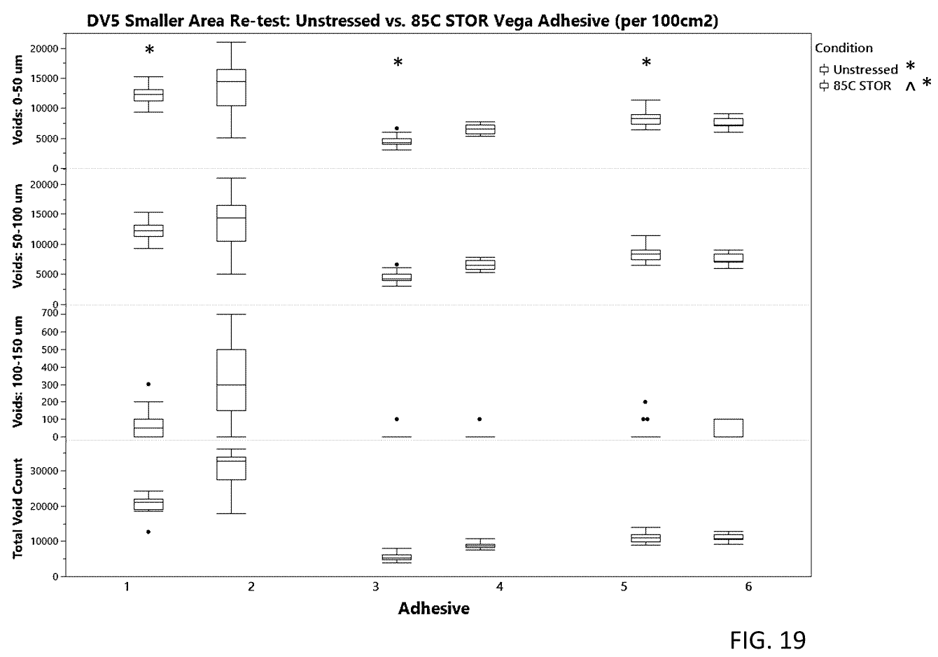

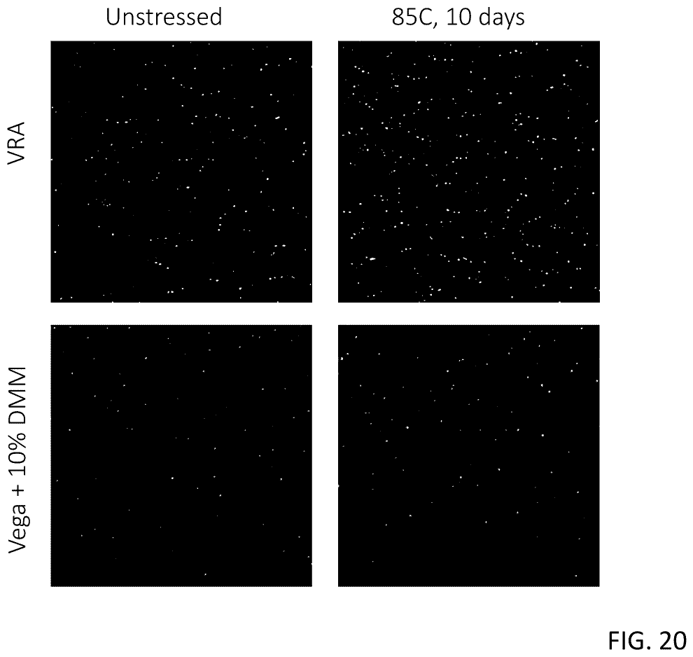

FIGS. 19-20 compare the void count between the 2000 ppm VRA control and Vega loaded with different levels of DMM. VRA adhesive showed an increase in total void count across all void sizes. Vega with DMM ASL showed stable void count at 85° C. storage for 10 days.

In summary, The UV overcoated 3-layer structure offers the following advantages: improvements in low temperature performance, thinner adhesive thickness achieved from the overcoating process without the risk of lamination voids, improvements in high temperature resolution with respect to lateral pixel coupling and better contrast by adding glycol ether co-solvent to UV Adhesive and CSL, improved activation energy, or reduced void count.

1. A conductive adhesive composition comprising:
from about 25 wt. % to about 45 wt. % of one or more acrylic or methacrylic oligomers;
from about 50 wt. % to about 75 wt. % of a monomer comprising acrylate;
from 0 to about 15 wt. % of a co-solvent comprising a glycol ether; and
an effective amount of a photoinitiator to initiate curing of the conductive adhesive composition;
wherein all weight percentages are percent by weight of the total composition.

2. The conductive adhesive composition of claim 1, wherein the glycol ether comprises dipropylene glycol dimethyl ether (DMM) or tripropylene glycol methyl ether (TPM).

3. The conductive adhesive composition of claim 1, wherein the one or more acrylic or methacrylic oligomers comprises aliphatic urethane acrylate, difunctional aliphatic urethane acrylate oligomer diluted with ethoxylated trimethylolpropane triacrylate, aliphatic urethane acrylate blended with isobornyl acrylate, tin-free aliphatic urethane acrylate oligomer, tin-free difunctional aliphatic urethane acrylate, low viscosity aliphatic urethane acrylate, tackifying acrylate, or combinations thereof.

4. The conductive adhesive composition of claim 3, wherein the monomer comprising acrylate comprises ethoxylated acrylate, 2-phenoxylethyl acrylate, 2-ethylhexyl acrylate, isodecyl acrylate, isooctyl acrylate, tridecyl acrylate, caprolactone acrylate, isobornyl acrylate, alkoxylated tetrahydrofurfuryl acrylates, alkoxylated phenol acrylates, benzyl (meth)acrylate, phenoxylethyl (meth)acrylate, phenol (EO)ₙ acrylate, methoxy PEG methacrylate, nonyl phenol (EO)ₙ acrylate, nonyl phenol (PO)₂ acrylate, and cyclic trimethylolpropane formal acrylate (CTFA) or combinations thereof, wherein n is selected from 2, 4, 6, and 8.

5. The conductive adhesive composition of claim 4, wherein the monomer comprising acrylate comprises ethoxylated acrylate, caprolactone acrylate, isobornyl acrylate, or combinations thereof.

6. The conductive adhesive composition of claim 1, wherein the conductive adhesive composition comprises from about 1 wt. % to about 10 wt. % of the photoinitiator.

7. The conductive adhesive composition of claim 1, wherein the conductive adhesive composition further comprises an adhesion promoter.

8. The conductive adhesive composition of claim 1, wherein—
the composition has a volume resistivity less than 10¹¹ Ohm·cm at −20° C.;
the composition has a volume resistivity less than 10¹⁰ Ohm·cm at 0° C.;
the composition has a volume resistivity less than 10⁹ Ohm·cm at 25° C.; or
any combinations thereof.

9. The conductive adhesive composition of claim 1, wherein the composition has a volume resistivity in the range of 10⁷ to 10¹² Ohm·cm between −20° C. to 60° C. optionally
wherein the composition has a volume resistivity in the range of 10⁸ to 10¹¹ Ohm·cm between −20° C. to 40° C.

10. The conductive adhesive composition of claim 1, wherein the composition has a Tg less than −20° C.

11. The conductive adhesive composition of claim 1, wherein the composition has an activation energy less than 0.80 eV.

12. The conductive adhesive composition of claim 1, wherein the composition comprises from about 5 wt. % to about 15 wt. % of the co-solvent.

13. An article of manufacture comprising a layer of the conductive adhesive composition according to claim 1 in contact with a layer of electrophoretic medium, wherein the layer of electrophoretic medium comprises microcapsules having a microcapsule wall and an internal phase comprising a dispersion solvent and charged pigment particles suspended in the internal phase and capable of moving through the dispersion solvent upon application of an electric field to the microcapsules.

14. The article of manufacture of claim 13, wherein the layer of the conductive adhesive composition comprises less than 20 gsm of the conductive adhesive composition in contact with the layer of electrophoretic medium.

15. The article of manufacture of claim 14, wherein the conductive adhesive composition is cured.

16. An electrophoretic display comprising:
a light-transmissive top electrode;
the article of manufacture according to claim 13; and
a backplane electrode;
wherein the conductive adhesive composition is positioned between the light-transmissive top electrode and the electrophoretic medium.

17. The electrophoretic display of claim 16, wherein the electrophoretic display has a Push Pull Sweep full gamut value over 15,000 at −20° C.

18. The electrophoretic display of claim 16, further comprising a second layer of adhesive material in contact with the layer of electrophoretic medium positioned between the backplane electrode and the layer of the electrophoretic medium.

19. The electrophoretic display of claim 18, wherein the second layer of adhesive material comprises from 0 to about 15 wt. % of the co-solvent comprising a glycol ether.

20. The electrophoretic display of claim 18, wherein the second layer of adhesive material further comprises a crosslinker and a dopant.

21. The electrophoretic display of claim 18, wherein the electrophoretic display has a Push Pull Sweep full gamut value over 40,000 at 65° C.
